(19) United States
(12) Patent Application Publication
(10) Pub. No.: US 2022/0305714 A1
(43) Pub. Date: Sep. 29, 2022

(54) APPARATUS FOR MANUFACTURING ADVANCED POLYMER COMPOSITE INCLUDING TORPEDO ASSEMBLY

(71) Applicant: GWG Inc., Seoul (KR)

(72) Inventor: Hyun-Jun KIM, Seoul (KR)

(73) Assignee: GWG Inc., Seoul (KR)

(21) Appl. No.: 17/212,502

(22) Filed: Mar. 25, 2021

(51) Int. Cl. B29C 48/255

(52) U.S. Cl. CPC B29C 48/2556

(57) ABSTRACT

According to the present disclosure, an apparatus for manufacturing advanced polymer composite including torpedo assembly includes a housing 16 supplied with a molten resin, a torpedo assembly 20 arranged on the inside of the housing 16 and having multiple resin channels 18 and 34 formed on a surface thereof in a longitudinal direction such that the molten resin flows, a dispersion portion 40 rotatably arranged on an outer circumferential surface of the torpedo assembly 20 and configured to uniformly disperse the molten resin and an additive by stirring the molten resin, a drive unit 50 for rotating the torpedo assembly 20 and the dispersion portion 40, multiple vent rings 22 in close contact with the outside of the dispersion portion 40 to discharge gas, and a head 24.

### TECHNICAL FIELD

The present disclosure relates to an apparatus for manufacturing advanced polymer composite including torpedo assembly, and more particularly, to a technology of improving physical properties by stirring a molten resin with a screw to uniformly disperse an additive such as graphene in the molten resin in the process of melting and extruding a resin as multiple screw shafts are arranged on an outer circumferential surface of a torpedo assembly in a circumferential direction to have a rotatable structure and of quickly separating and discharging impure gas.

### BACKGROUND ART

In general, polymer resin materials have been widely used due to excellent moldability, productivity, and uniform quality and have disadvantage of being weak against heat and external impacts, and thus, there is a need for developing an advanced material that may solve the disadvantage.

Due to this, a reinforcing material is mixed with a polymer resin, and thereby, physical properties such as strength and elastic modulus of a product, electromagnetic wave shielding, electrical conductivity, and so on may be increased. The reinforcing material may include various materials, for example, a metal material such as aluminum or stainless steel, an organic material such as aramid or poly-phenylene benzobisoxazole (PBO), an inorganic material such as silicon carbide, graphene, a carbon material, and so on are mixed with a resin to be used.

In the process of manufacturing the polymer resin and the reinforcing material, a molten resin passes through an injection molding or extrusion molding machine, and a filter assembly for discharging impure gas included in the discharged molten resin is included in exit sides of a catapult and an extruder.

The filter assembly generally includes a hollow body to which a molten resin is supplied; a head that is coupled to an exit side of the body and includes a discharge hole for discharging the molten resin; a torpedo that is arranged inside the body to remove gas from the molten resin passing through the body; and multiple vent rings that are inserted outside the torpedo and filter impure gases from the molten resin.

In the filter assembly, multiple flow grooves are formed on a surface of the torpedo, and the molten resin flows along the flow grooves.

In addition, the impure gas included in the molten resin during flowing is discharged, and the discharged gas may be discharged between the multiple vent rings.

However, the filter assembly of the related art has the following problems.

First, while a molten resin passes through multiple flow grooves formed in a torpedo, an additive such as graphene is partially agglomerated in the molten resin, and thus, a physical property of a molded article is degraded.

Second, while a molten resin passes through multiple flow grooves formed in a torpedo, impure gas included in the molten resin may not be sufficiently separated from the molten resin.

Third, a molten resin passes through a torpedo at high pressure and speed, and thus, the molten resin may leak through multiple vent rings during the process.

### SUMMARY OF INVENTION

### Technical Problem

An object of the present disclosure is to provide a technology of improving physical properties by stirring a molten resin with a screw to uniformly disperse an additive such as graphene in the molten resin in the process of melting and extruding a resin and of quickly separating and discharging impure gas.

### Solution to Problem

According to an embodiment of the present disclosure, an apparatus for manufacturing advanced polymer composite including torpedo assembly includes a housing 16 supplied with a molten resin mixed with an additive and including a gas outlet 12 and a gas inlet 14; a torpedo assembly 20 arranged in a lengthwise direction in a hollow formed on the inside of the housing 16 and includes multiple resin channels 18 and 34 formed on a surface in a longitudinal direction and configured to discharge gas included in the molten resin while the molten resin flows through the resin channels 18 and 34 under a certain pressure; a dispersion portion 40 rotatably arranged on an outer circumferential surface of the torpedo assembly 20 in a circumferential direction and configured to uniformly disperse the molten resin and an additive by stirring the molten resin flowing along the resin channels 18 and 34; a drive unit 50 included in the housing 16 to rotate the torpedo assembly 20 and the dispersion portion 40; multiple vent rings 22 configured to be in contact with an external portion of the dispersion portion 40 and configured to seal outer radius openings of the resin channels 18 and 34 to prevent the molten resin from leaking to allow the molten resin to flow in the longitudinal direction and configured to discharge gas included in the molten resin through gaps t; and a head 24 coupled to the other side of the housing 16 to discharge a resin passing through the torpedo assembly 20 and configured to pressurize the multiple vent rings 22 to be in close contact with each other.

Advantageous Effects

An apparatus for manufacturing advanced polymer composite including torpedo assembly according to an embodiment of the present disclosure has following effects.

First, since multiple screw shafts are arranged on an outer circumferential surface of a torpedo assembly in a circumferential direction to be rotatable, when the molten resin passes through multiple resin channels of the torpedo assembly, a screw stirs the molten resin to effectively mix various additives such as graphene, carbon, and carbon nanotube (CNT) with polymer, and thus, physical properties may be improved, and impure gas may be quickly separated and discharged.

Second, a molten resin and an additive are stirred by rotating a screw, and thus, not only a liquid additive but also a solid powdered additive may be effectively dispersed in the molten resin.

### BRIEF DESCRIPTION OF DRAWINGS

FIG. 1 is a view schematically showing a structure of an apparatus for manufacturing advanced polymer composite including torpedo assembly according to an embodiment of the present disclosure.

FIG. 2 is an exploded perspective view showing a structure of a torpedo assembly shown in FIG. 1.

FIG. 3 is a perspective view showing the structure of the torpedo assembly for removing gas included in a molten resin shown in FIG. 1.

FIG. 4 is a side cross-sectional view showing the structure of the torpedo assembly shown in FIG. 1.

### DETAILED DESCRIPTION OF EMBODIMENTS

Hereinafter, an apparatus for manufacturing advanced polymer composite including torpedo assembly according to an embodiment of the present disclosure will be described in detail with reference to the accompanying drawings.

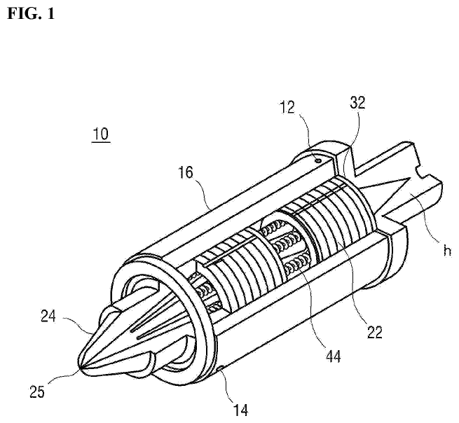

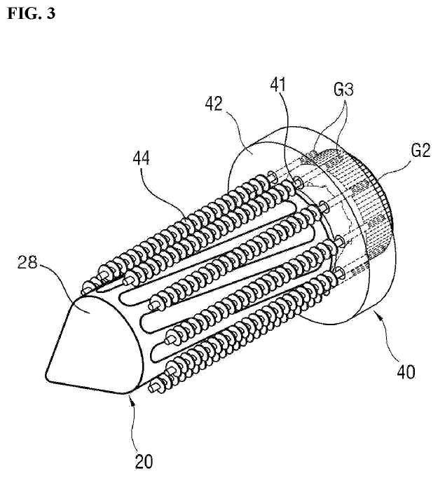

As shown in FIGS. 1 to 4, the apparatus for manufacturing advanced polymer composite including torpedo assembly polymer proposed by the present disclosure is used to increase quality of a molten resin by removing impure gas included in the molten resin and is mounted on an exit side of, for example, a catapult or an extruder.

The apparatus for manufacturing advanced polymer composite including torpedo assembly 10 includes a housing 16 that is supplied with a molten resin mixed with an additive and includes a gas outlet 12 and a gas inlet 14; a torpedo assembly 20 that is arranged in a lengthwise direction in a hollow formed on the inside of the housing 16 and includes multiple resin channels 18 and 34 formed on a surface thereof in a longitudinal direction and discharges gas included in the molten resin while the molten resin flows through the resin channels 18 and 34 under a certain pressure; a dispersion portion 40 that is rotatably arranged on an outer circumferential surface of the torpedo assembly 20 in a circumferential direction and uniformly disperses the molten resin and an additive by stirring the molten resin flowing along the resin channels 18 and 34; a drive unit 50 that is included in the housing 16 to rotate the torpedo assembly 20 and the dispersion portion 40; multiple vent rings 22 that are in contact with an external portion of the dispersion portion 40 and seal outer radius openings of the resin channels 18 and 34 to prevent the molten resin from leaking to allow the molten resin to flow in the longitudinal direction and discharge gas included in the molten resin through a gap t; and a head 24 that is coupled to the other side of the housing 16 to discharge a resin passing through the torpedo assembly 20 and pressurizes the multiple vent rings 22 to be in close contact with each other.

When describing the polymer composite advanced-material manufacturing apparatus 10 in more detail, the housing 16 includes a hollow formed in the longitudinal direction therein and a molten resin supply portion 31 formed at a rear end thereof, thereby being coupled to the exit side of the catapult (not shown). Accordingly, a molten resin discharged from the catapult is supplied to the torpedo assembly 20 through a supply hole h formed in the molten resin supply portion 31.

In addition, the head 24 may be screwed to a front end of the housing 16.

The torpedo assembly 20 is arranged in the hollow formed inside the housing 16 to separate and discharge impure gas included in the supplied molten resin.

This torpedo assembly 20 includes a body 28; the multiple resin channels 18 and 34 that are concavely formed in a longitudinal direction on an outer peripheral surface of the body 28 to allow the molten resin to flow the resin channels; and a support member 32 that is arranged radially at one end of the body 28 and includes multiple inlet holes 30 formed at a predetermined interval in a circumferential direction to correspond to the multiple resin channels 18 and 34, and the molten resin supplied through the molten resin supply portion 31 is supplied to the resin channels 18 and 34 through the inlet hole 30.

In more detail, the body 28 has a cylindrical shape and includes a first wedge W1 protruding from one side (catapult direction) and a second wedge W2 protruding from the other side (head direction).

As the first wedge W1 is formed to protrude in the catapult direction, the molten resin discharged from the catapult is injected through the supply hole h to be supplied to the torpedo assembly 20 in properly dispersed state in the process of being delivered along the first wedge W1 having a conical shape.

In addition, the multiple resin channels 18 and 34 are formed on an outer circumferential surface of the body 28 at a predetermined depth in the longitudinal direction, and thereby, the molten resin may flow through the resin channels.

The multiple resin channels 18 and 34 include a first flow channel 18 formed concavely on a surface of the body 28, a second flow channel 34 arranged side by side adjacent to the first flow channel 18 such that a molten resin of the first flow channel 18 overflows and is supplied to the second flow channel, and a protruding jaw 35 that protrudes between the first and second flow channels 18 and 34 and partitions the first and second flow channels 18 and 34 such that the molten resin of the first flow channel 18 may overflow into the second flow channel 34.

The multiple first and second flow channels 18 and 34 and the protruding jaws 35 are formed in a longitudinal direction on a circumferential surface of the body 28 and are sequentially arranged in a circumferential direction.

In this case, the multiple first and second flow channels 18 and 34 and the protruding jaws 35 are inclined at a certain angle with respect to a longitudinal center line of the body 16 or are formed in a parallel direction.

Accordingly, the molten resin supplied through the supply hole h flows into the first and second flow channels 18 and 34 through the inlet hole 30 of the support member 32 and flows toward the head 24.

In addition, a part of the molten resin that reaches front ends of the first and second flow channels 18 and 34 may be discharged toward the head 24 through fine discharge holes 33 formed at the front end or may be discharge by overflowing the front end.

In addition, the dispersion portion 40 has a structure of surrounding the body 28 by being arranged in the circumferential direction on the outer circumferential surface of the body 28 of the torpedo assembly 20.

The dispersion portion 40 includes a base 42 arranged in an inner space of the housing 16; rotary shafts 41, each having one side rotatably inserted into one of multiple support holes h1 formed in the base 42 in a circumferential direction; passive gears G3, each being provided at one end of one of the rotary shafts 41 and screwed to an intermediate gear G2 formed on an outer circumferential surface of the support member 32; and screws 44, each being provided at the other end of one of the rotary shafts 41 to uniformly disperse an additive by stirring the molten resin flowing through the first and second flow channels 18 and 34.

In more detail, the base 42 has a disk shape and has an insertion hole h2 formed in the middle thereof. Accordingly, as the body 28 of the torpedo assembly 20 passes through the insertion hole h2, the body 28 may be integrally coupled to the dispersion portion 40. In addition, the base 42 may have variously shapes such as a circular ring shape.

In addition, multiple support holes h1 are formed in the base 42 in a circumferential direction to penetrate the base 42, and one end of the rotary shaft 41 is inserted into the support hole h1. In this case, one end of the rotary shaft 41 is coupled to the support hole h1 by a bearing.

Accordingly, when a rotational force is applied to the rotary shaft 41, one end of the rotary shaft 41 is rotatable in a state of being coupled to the base 42.

In addition, multiple screws 44 are arranged at a front end of the rotary shaft 41 in a longitudinal direction. In this case, the screws 44 maintains an interval so as not to interfere with the screws 44 of the adjacent rotary shaft 41.

The rotary shaft 41 may be rotated by the drive unit 50.

That is, the drive unit 50 includes a motor M provided in the housing 16; and a drive gear G1 connected to the rotary shaft 41 of the motor M to be screwed to the intermediate gear G2 of the support member 32.

Accordingly, when the motor M is driven, the drive gear G1 rotates the body 28 of the torpedo assembly 20 by rotating the support member 32 through the intermediate gear G2, and at the same time, rotates the screws 44 by rotating the rotary shaft 41 through the passive gear G3.

In this case, a rotation direction of the body 28 and a rotation direction of the rotary shaft 41 are opposite to each other.

That is, when the body 28 rotates in a forward direction, the rotary shaft 41 rotates in a reverse direction.

In addition, the screw 44 corresponds to the multiple resin channels 18 and 34. Accordingly, when the screw 44 rotates, a molten resin may be stirred as rims of the screws 44 come into contact with the molten resin flowing through the multiple resin channels 18 and 34.

In addition, as the molten resin is stirred, an additive included in the molten resin may be uniformly dispersed. In particular, not only a liquid additive but also a solid additive may be mixed with the molten resin to be uniformly dispersed.

Meanwhile, the multiple vent rings 22 are arranged outside the dispersion portion 40, and the vent rings 22 are coupled to be in close contact with each other.

Accordingly, when the molten resin flows through the multiple resin channels 18 and 34, the molten resin may flow without leaking to the outside.

In addition, during this process, gas included in the molten resin may be discharged to the outside by passing through spaces between the multiple vent rings 22 inserted outside the body 28.

In this case, the molten resin overflows the protruding jaws 35 from the first flow channel 18 and flows into the adjacent second flow channel 34, and during this process, the molten resin also spreads with a thin thickness.

In addition, because the molten resin is in a thin and uniformly spread state, gas included in the molten resin may be effectively discharged.

In addition, because a conductive material included in the molten resin is uniformly distributed over the entire area, conductivity may be increased.

In this way, the molten resin passing through the resin channels 18 and 34 flows along the second wedge W2 of a conical shape, and thus, the molten resin may be discharged more effectively.

Meanwhile, because the molten resin flowing through the first and second resin channels 18 and 34 is in a state of being stirred and is under a certain pressure, gas included in the molten resin is discharged to the outside.

In addition, the discharged gas may be discharged to the outside through spaces between the multiple vent rings 22 inserted outside the body 28.

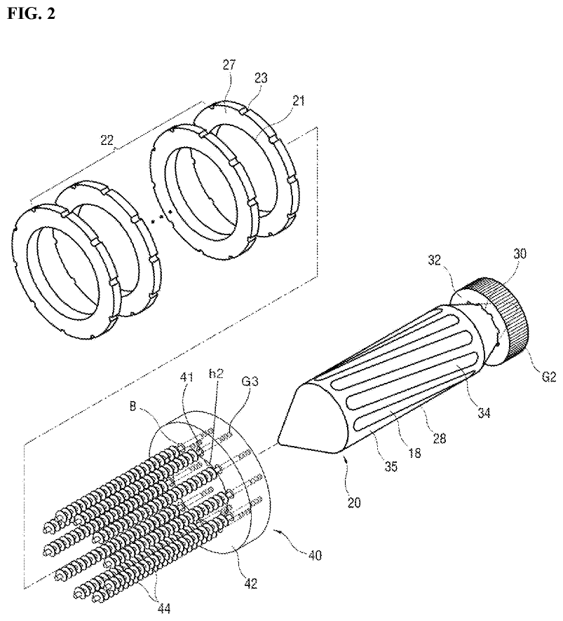

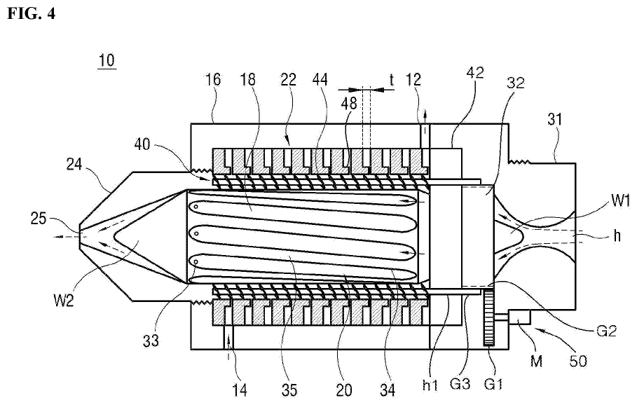

In more detail, as shown in FIGS. 2 and 4, each of the multiple vent rings 22 includes a ring portion 27 that has a ring shape and includes an insertion hole 21 formed inside a radius; a spacer 48 that protrudes along a circumferential direction of the ring portion 27 around the insertion hole 21 in front of the ring portion 27 to be in contact with a rear surface of the adjacent vent ring 22 such that a rim of the ring portion 27 is spaced apart from a rim of the adjacent vent ring 22; and a discharge groove 23 formed concavely in a circumferential surface of the ring portion 27 in a longitudinal direction to serve as a discharge passage for gas.

The ring portion 27 has a circular ring shape and the insertion hole 21 formed therein. Accordingly, as the body 28 of the torpedo assembly 20 is inserted into the insertion holes 21, the vent rings 22 may be coupled to the body 28. In this case, inner circumferential surfaces of the insertion holes 21 of the vent rings 22 and an outer circumferential surface of the body 28 are closely coupled to each other, and thus, a molten resin is prevented from leaking into the gap t.

Accordingly, the molten resin flowing inside the resin channels 18 and 34 may not be discharged between the vent rings 22, and only the gas included in the molten resin is discharged.

In addition, because the ring portion 27 has the spacer 48 formed to protrude in a lateral direction, the ring portion 27 is in contact with a rear surface of the adjacent ring portion 27, and thereby, the gap t having a predetermined interval between rims of the ring portions 27 is formed.

Accordingly, while the molten resin flows through the multiple resin channels 18 and 34, impure gas included in the molten resin is discharged, and this gas may be discharged between the vent rings 22.

In this case, the multiple discharge grooves 23 are formed concavely in the circumferential surface of the vent ring 22. That is, the discharge grooves 23 are formed at a predetermined depth in the circumferential surface of the vent ring 22, and the discharge grooves 23 are arranged at a predetermined distance from each other.

In addition, the discharge grooves 23 formed in each of the venting rings 22 are arranged in the same line as the discharge grooves 23 of the adjacent vent ring 22.

Accordingly, gas collected in the gap t of each of the vent rings 22 may flow through the multiple discharge grooves 23 and then may flow sequentially through the discharge grooves 23 of the adjacent vent ring 22 and then may be discharged to the outside through the gas outlet 12 formed in the housing 16.

In this case, the gas inlet 14 is formed on the other side of the housing 16 in order to discharge gas more effectively. Accordingly, an inner space of the housing 16 communicates with the outside through the gas inlet 14 to be in an atmospheric pressure, and thus, gas discharged from the torpedo assembly 20 may be discharged more effectively through the gas outlet 12.

In this case, it is preferable that the gas inlet 14 and the discharge grooves 23 are arranged as far apart from each other as possible.

In addition, the head 24 is coupled to the other side of the housing 16, and thus, the molten resin passing through the torpedo assembly 20 may be discharged to the outside.

A rear end of the head 24 is screwed to an outlet of the housing 16, and a nozzle 25 is formed at a front end of the head. Accordingly, a molten resin supplied along the second wedge W2 of the torpedo assembly 20 may be discharge through the nozzle 25.

In this case, the second wedge W2 has a conical shape such that a molten resin is compressed while flowing along a surface of the second wedge W2, and thus, the molten resin may be discharged more effectively.

In addition, the discharged molten resin is extruded and molded as a die or a mold, and a wood-plastic composite pellet may be manufactured by mounting a pellet manufacturing device at an exit of the die, or an injection product may be manufactured by injecting the molten resin into a mold.

1. An apparatus for manufacturing advanced polymer composite including torpedo assembly comprising:
a housing 16 supplied with a molten resin mixed with an additive and including a gas outlet 12 and a gas inlet 14;
a torpedo assembly 20 arranged in a lengthwise direction in a hollow formed on the inside of the housing 16 and includes multiple resin channels 18 and 34 formed on a surface in a longitudinal direction and configured to discharge gas included in the molten resin while the molten resin flows through the resin channels 18 and 34 under a certain pressure;
a dispersion portion 40 rotatably arranged on an outer circumferential surface of the torpedo assembly 20 in a circumferential direction and configured to uniformly disperse the molten resin and an additive by stirring the molten resin flowing along the resin channels 18 and 34;
a drive unit 50 included in the housing 16 to rotate the torpedo assembly 20 and the dispersion portion 40;
multiple vent rings 22 configured to be in contact with an external portion of the dispersion portion 40 and configured to seal outer radius openings of the resin channels 18 and 34 to prevent the molten resin from leaking to allow the molten resin to flow in the longitudinal direction and configured to discharge gas included in the molten resin through gaps t; and
a head 24 coupled to the other side of the housing 16 to discharge a resin passing through the torpedo assembly 20 and configured to pressurize the multiple vent rings 22 to be in close contact with each other.

2. The apparatus for manufacturing advanced polymer composite including torpedo assembly of claim 1, wherein
the torpedo assembly 20 includes a body 28, the multiple resin channels 18 and 34 concavely formed in a longitudinal direction on an outer peripheral surface of the body 28 to allow the molten resin to flow the multiple resin channels 18 and 34, and a support member 32 arranged radially at one end of the body 28,
the support member 32 includes multiple inlet holes 30 formed at a predetermined interval in a circumferential direction to correspond to the multiple resin channels 18 and 34, and
the molten resin supplied through a molten resin supply portion 31 is supplied to the resin channels 18 and 34 through the inlet hole 30.

3. The apparatus for manufacturing advanced polymer composite including torpedo assembly of claim 2, wherein
the multiple resin channels 18 and 34 include the first flow channel 18 formed concavely on a surface of the body 28, the second flow channel 34 arranged side by side adjacent to the first flow channel 18 such that the molten resin of the first flow channel 18 overflows and is supplied to the second flow channel 34, and a protruding jaw 35 that protrudes between the first flow channels 18 and the second flow channel 34 and partitions the first flow channel 18 and the second flow channel 34 such that the molten resin of the first flow channel 18 overflows into the second flow channel 34, and
the first flow channel 18 and the second flow channel 34 and the protruding jaws 35 are repeatedly arranged along a circumferential surface of the body 28.

4. The apparatus for manufacturing advanced polymer composite including torpedo assembly of claim 1, wherein
the dispersion portion 40 includes a base 42 arranged in an inner space of the housing 16; rotary shafts 41 each having one side rotatably inserted into one of multiple support holes h1 formed in the base 42 in a circumferential direction; passive gears G3, each being provided at one end of one of the rotary shafts 41 and screwed to an intermediate gear G2 formed on an outer circumferential surface of the support member 32; and screws 44 each being provided at the other end of one of the rotary shafts 41 to uniformly disperse an additive by stirring the molten resin flowing through the first flow channel 18 and the second flow channel 34, and
when the drive unit 50 rotates the intermediate gear G2, the passive gears G3 rotate to rotate the rotary shafts 41 such that the screws 44 stir the molten resin of the first flow channel 18 and the second flow channel 34.

5. The apparatus for manufacturing advanced polymer composite including torpedo assembly of claim 4, wherein
the drive unit 50 includes a motor M provided in the housing, and a drive gear G1 connected to a rotary shaft of the motor M and screwed to the intermediate gear G2 of the support member 32, and
when the motor M is driven, the drive gear G1 rotates the body 28 of the torpedo assembly 20 by rotating the support member 32 through the intermediate gear G2, and at the same time, rotates the rotary shafts 41 through the passive gears G3 to rotate the screws 44.

6. The apparatus for manufacturing advanced polymer composite including torpedo assembly of claim 1, wherein
the multiple vent rings 22 include ring portions 27 that each have a ring shape and each include an insertion hole 21 formed inside a radius; spacers 48 that protrude along a circumferential direction of each of the ring portions 27 around the insertion holes 21 in front of the ring portions 27 to be in contact with rear surfaces of the adjacent vent rings 22 such that rims of the ring portions 27 are spaced apart from rims of the adjacent vent rings 22; and discharge grooves 23 formed concavely in circumferential surfaces of the ring portions 27 in a longitudinal direction to serve as discharge passages for gas, and
gas included in the molten resin flowing through the resin channels 18 and 34 moves through the gaps t between the spacers 48 and the discharge grooves 23 to be discharged to the outside through the gas discharge hole 12.
